(19) United States
(12) Patent Application Publication
(10) Pub. No.: US 2008/0318759 A1
(43) Pub. Date: Dec. 25, 2008

(54) Method of Producing Porous Ceramic Supports of Controlled Microstructure

(75) Inventors: Nicolas Richet, Fontenay-Le-Fleury (FR); Pascal Del-Gallo, Dourdan (FR); Laetitia epouse Pajot Trebuchaire, Feytiat (FR); Christophe Chaput, Le Palais Sur Vienne (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Exloitation Des Procedes Georges Claude, Paris (FR)

(21) Appl. No.: 12/093,852

(22) PCT Filed: Nov. 3, 2006
(86) PCT No.: PCT/EP2006/068061

§ 371 Date: Jul. 17, 2008

(30) Foreign Application Priority Data
Nov. 15, 2005 (EP) 05300928.8

(51) Int. Cl. C04B 38/00

(52) U.S. Cl. 501/80

(57) ABSTRACT

Process for producing a ceramic part from a ceramic powder, comprising the following successive steps: a step (a) of deagglomerating the ceramic powder in liquid phase; a step (b) of incorporating pore formers into the powder dispersion prepared in step (a); a step (c) of removing the liquid medium from the dispersion prepared in step (b); a step (d) of forming agglomerates form the powders obtained in step (c); a step (e) of removing the binder from the preform prepared in step (d); and a step (f) of sintering the binderless part prepared in step (e).

The invention relates to the production of porous ceramics.

The development of porosity in a ceramic is obtained by four methods, which are: consolidation of a non-compacted stack of particles; impregnation of a preform with a ceramic suspension and densification of the structure formed; control of the microstructure of a precursor of the ceramic to be produced; the addition of a secondary phase which, after removal, leaves residual porosity.

A stack of ceramic particles for forming the porosity has been described, for example, in the International Application published under the number WO 03/070661, in United States patent published under the number U.S. Pat. No. 6,617,270 B1 and in United States patent application published under the number US 2003/039774 A1. This technique uses the particle size distribution so as to produce a non-compact stack of particles. A blend of coarse and fine particles provides bridging between the largest particles. The pore size distribution is difficult to control as it is dependent on the ceramic particle size distribution and on the production process. The mechanical strength of the material is limited by the solidity of the inter-particle bridges. This stack technique results in a final microstructure that is “uncontrolled”, especially in terms of pore distribution or pore size homogeneity.

The impregnation of a preform, often of organic nature, with a ceramic suspension also allows a porous structure to be produced. This method is described for example in United States patent published under the U.S. Pat. No. 5,066,432 or in the International Application published under the number WO 01/60515. After thermal decomposition of the preform, the ceramic strands formed are densified by sintering. The porosity structure depends directly on that of the organic preform used and on the wetting by the suspension. There is a great amount of open porosity as this is necessary for good impregnation of the preform. The mechanical strength of these materials is dependent on the size of the preform strands. This technique is employed for producing ceramic foams. One of the difficulties is the absence of macroporosity and microporosity (at strand level), the total porosity often being that of the impression of the preform. This technique results in a porosity derived from the preform with, as main drawback, the difficulty of removing the organics. It is also very difficult with this technique to obtain a low porosity (<40%). This requires the foam to be uniformly filled with the ceramic suspension, which poses technical problems such as the dimensions of the parts.

The formation of lower open porosity, by controlling the microstructure of a ceramic precursor, generally in the form of a gel, has been described in United States Patents published under the U.S. Pat. Nos. 5,227,342 and 6,645,571 B1 and also in United States patent applications published under the numbers US 2004/0185181 A1 and US 2003/052428 A1. The porosity may be adjusted by controlling the degree of agglomeration of the ceramic particles. This technique is therefore comparable to the technique of forming porosity from a stack of particles, with the compactness of the stack being modified according to the state of agglomeration of the ceramic particles. Organic compounds may also be used to structure the ceramic particles in a suspension. Micelles bearing surface electric charge may attract the ceramic particles by electrostatic effect and, after drying and decomposition, a porous structure may be formed, which will be consolidated by sintering. Another version of this method, described in United States patent published under the number U.S. Pat. No. 6,645,571 B1, consists in foaming a suspension before the structure is gelled. However, this version cannot be easily extrapolated for industrial-scale production or for producing large parts.

The incorporation of a secondary, often organic, phase, which after calcination leaves a certain porosity, is described in United States patents published under the numbers U.S. Pat. No. 6,617,270 B1 and U.S. Pat. No. 6,573,208 B1 and also in European Patent Application published under the number EP 0 983 980 A. The structure of the porosity is directly dependent on the amount of secondary phase introduced, on the particle size distribution and on their distribution around the ceramic particles. According to the technical teaching of EP 0 983 980, the mechanical properties are not degraded using at least two particle-size classes for the pore former. This technique is, together with the “particle stack control” technique, the most widely used on an industrial scale.

The inventors have therefore sought to develop a novel process for producing porous ceramics which makes it possible to control and/or improve the control of the characteristics of its porous microstructure, especially the size and distribution of the pores, the size of the particles constituting the ceramic backbone, and the total pore volume.

The proposed invention relates to a production process for controlling the microstructure of a porous ceramic. This process makes it possible to vary at will two principles used to create porosity-particle stacking and addition of a pore former.

The subject of the invention is therefore a process for producing a ceramic part from a ceramic powder, comprising the following successive steps:

a step (a) of deagglomerating the ceramic powder in liquid phase;

a step (b) of incorporating pore formers into the powder dispersion prepared in step (a);

a step (c) of removing the liquid medium from the dispersion prepared in step (b);

a step (d) of forming agglomerates from the powders obtained in step (c);

a step (e) of removing the binder from the preform prepared in step (d); and

a step (f) of sintering the binderless part prepared in step (e).

The objective of step (a) of the process as defined above is the control of the intra-agglomerate porosity. The expression “deagglomeration of the powder” is understood to mean the action whereby the particle agglomerates that form during the production and/or storage of the powder are broken up. By controlling this step, it is therefore possible to control the volume of the residual intra-agglomerate porosity in the final material. The deagglomeration may be carried out in a liquid phase, such as water or ethanol, or in a jar with milling media, for example zircona balls. The parameters that have to be controlled are the relative volumes of powder and deagglomerating media with respect to that of the jar, the quantity of liquid phase, the nature of the deagglomerating media, which may introduce contamination, the jar rotation speed and the duration of the treatment.

The process as defined above may optionally include a step (a1) of introducing one or more additives, chosen from dispersants, binders and/or plasticizers, into the powder dispersion prepared in step (a) and prior to the implementation of step (b). The introduction of such organic compounds is intended to make the forming operation easier.

By introducing a dispersant it is possible to stabilize the powder dispersion obtained after step (a). The nature and the amount of dispersant to be introduced into the suspension are determined by means of tools used by those skilled in the art. They depend essentially on the nature of the liquid phase used, on the nature of the ceramic powder, on the morphology and on the specific surface area of the ceramic powder. Adsorption is achieved under the same conditions as for deagglomeration, by introducing a defined amount of dispersant into the jar and by continuing the treatment for the time needed to adsorb it. The proper deagglomeration of the powder is checked by measuring the particle size distribution and the specific surface area of the powder. The powder may also be observed using a scanning electron microscope in order to check its state. As dispersant, mention may be made for example of phospholan. A deagglomeration treatment lasting 5 hours allows the particle size distribution to be stabilized.

The binders and plasticizers are necessary when the subsequent forming operation is carried out by extrusion or by injection moulding, which are operations that involve plastic deformation of the ceramic paste in order to obtain the desired geometry. The binder improves the cohesion to the ceramic paste and the plasticizer facilitates the deformation thereof. The amounts of each of the additives employed are adapted according to the chosen forming technique.

Various types of pore former may be used in step (b) of the process as defined above in order to create the porosity in the final material: either synthetic pore formers or natural pore formers. The choice of pore former type depends mainly on the shape, the size and the distribution of the desired porosity. A synthetic organic agent will be preferred for its spherical and regular shape and for its perfectly controlled particle size distribution, unlike a natural pore former of the corn starch or coconut shell type. The choice of particle size distribution and the choice of the pore former depends mainly on the size of the pores and on the desired pore volume. Thus, to obtain an interconnected pore volume, it is essential to take into account the closure of the smallest pores that are created by the finest particles of the pore former. This is because, after its removal, the process of densifying the ceramic matrix may cause certain pores to close up. Consequently, the amount of pore former introduced into the ceramic structure must be approximately 1.5 times higher than the desired final pore volume in the ceramic matrix.

Moreover, the second selection criterion is the particle size distribution of the pore former(s), which defines the size of the pores, their interconnections and the final pore distribution. Thus, a pore former of narrow particle size distribution, between 5 μm and 40 μm, will result in pores with a size close to 20 μm. After this step, the ceramic powder may contain up to 30% to 40% of its mass as organic products.

The objective of step (c) of the process as defined above is to remove the liquid phase used for the deagglomeration and for the optional incorporation of the organic additives. This step is a strong influence on the uniformity of the pore former distribution in the powder to be formed. It may also make it easier for the powder to be used during the forming operation, thanks to the control of the particle morphology. The liquid phase may be removed in various ways, either by simple evaporation in an oven, or by evaporation in a rotary evaporator, or by spray-drying the powder, in order to form agglomerates containing the pore former and the binder, or by centrifugation, or by filtration.

The first removal technique is the easiest to implement. However, it requires a few precautions to be taken in order to prevent sedimentation of the pore former. The suspension is therefore cast onto plates as a thin film before being slowly dried in an oven at 80° C. Quite a homogeneous distribution of the pore former is obtained.

When a rotary evaporator is used, the movement imparted to the suspension during evaporation of the solvent makes it possible to reduce sedimentation of the pore former. This technique is difficult to implement on an industrial scale.

A third technique allows a large quantity of the suspension to be dried—this is spray drying. It consists in sending the suspension in the form of droplets of controlled size into a heated chamber. The droplets are dried during their flight through the chamber, thereby producing ceramic particle/pore former agglomerates of good sphericity. The forming operation is much easier to implement on this type of powder owing to its good flowability obtained by the regular shape of the particles. This technique can be used on an industrial scale.

Step (c) of the process as defined above generally results in powder agglomerates that are subjected to the forming step (d).

According to one aspect of the process as defined above, step (c) of removing the liquid medium is carried out evaporation or by spray-drying the powder.

The forming operation applied in step (d) of the process as defined above is chosen according to the shape, the complexity and the size of the part to be produced. For example: isostatic pressing or uniaxial pressing is used to produce quite simple parts of small to moderate size; injection moulding is used to produce small parts of complex shape; extrusion is used for sections; tape casting is used to produce plates; casting in plaster moulds is used to produce hollow parts.

According to one particular aspect of the process as defined above, when the forming operation is carried out by casting in a plaster mould, step (c) of removing the water forms an integral part of forming step (d), the water being absorbed by said plaster mould.

According to another aspect of the process as defined above, step (d) is carried out by isostatic pressing, uniaxial pressing, injection moulding, extrusion or tape casting of the powder agglomerates prepared in step (c).

Step (e) of removing the binder from the preform prepared in step (d) consists of a heat treatment carried out between the temperature at which the organic constituents present in the powder start to degrade and the temperature at which their degradation is complete, generally between 100° C. and 800° C. The rate of temperature rise is slow, for example between 0.2° C./min and 0.5° C./min, in order to allow the organic compounds to leave progressively. The temperature is kept constant over the time needed for the organic substances present to be completely removed. This time may vary from a few minutes to a few hours. Their removal must be perfectly controlled in order to avoid the appearance of defects in the stack of ceramic particles. After the binder removal step, the mechanical strength of the part is extremely low as it is only provided by the interactions between the ceramic particles compacted during the forming step.

Step (f) for sintering the binderless part prepared in step (e) allows the ceramic to be densified without, however, closing the residual pores, left by the pore former, and/or the intra-agglomerate pores. The latter may be partially or completely closed depending on the temperature and duration of the treatment. After sintering, the part obtained has a pore size distribution that depends on the size of the pore former particles and on the residual intra-agglomerate pores.

In the process as defined above, the ceramic is an ionic conductor, preferably an ionic/electronic conductor, which comprises more particularly at least one crystal lattice having at least one oxygen vacancy, said ceramic being, for example, chosen from ceramics of perovskite structure and cerium oxides. It is characterized in terms of pore volume, pore size, interconnections between the pores, and pore distribution by mercury porosimetry analysis. The microstructure is examined by scanning electron microscopy and tested for permeability.

According to one aspect of the present invention, the subject of the latter is the process as defined above in which the ceramic powder employed is a powder of material (A) comprising per 100% of its volume.

(i)—at least 75% by volume and at most 100% by volume of a compound (C₁) chosen from doped ceramic oxides which, at the use temperature, are in the form of a crystal lattice with oxide ion vacancies of perovskite phase, of formula (I):

Mα₁₋ₓ₋ᵤMα′ₓMα″ᵤMβ′_{y}Mβ″ᵥO_{3-w} (I)

in which:
Mα represents an atom chosen from scandium, yttrium or from the families of lanthanides, actinides or alkaline-earth metals;
Mα′, which differs from Mα, represents an atom chosen from scandium, yttrium or from the families of lanthanides, actinides or alkaline-earth metals;
Mα″, which differs from Mα and Mα′, represents an atom chosen from aluminium (Al), gallium (Ga), indium (In), thallium (Tl) or from the family of alkaline-earth metals;
Mβ represents an atom chosen from transition metals;
Mβ′, which is different from Mβ, represents an atom chosen from transition metals, aluminium (Al), indium (In), gallium (Ga), germanium (Ge), antimony (Sb), bismuth (Bi), tin (Sn), lead (Pb) or titanium (Ti);
Mβ″, which differs from Mβ and Mβ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9
and w is such that the structure in question is electrically neutral;

(ii)—optionally up to 25% by volume of a compound (C₂), which differs from compound (C₁), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃); calcium phosphates and their derivatives, such as hydroxyapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O_{3-δ}, La_{0.6}Sr_{0.4}Fe_{0.9}Ga_{0.1}O_{3-δ}, La_{0.5}Sr_{0.5}Fe_{0.9}Ga_{0.1}O_{3-δ} or La_{0.6}Sr_{0.4}Fe_{0.9}Ti_{0.1}O_{3-δ} or else from materials of the non-oxide type, preferably chosen from carbides or nitrides such as silicon carbide (SiC), boron nitride (BN), aluminium nitride (AlN) or silicon nitride (Si₃N₄), “sialons” (SiAlON), or from nickel (Ni), platinum (Pt), palladium (Pd) or rhodium (Rh); metal alloys or mixtures of these various types of material; and,

(iii)—optionally up to 2.5% by volume of a compound (C₁₋₂) produced from at least one chemical reaction represented by the equation:

xF_{C1}+yF_{C2}------>zF_{C1-2},
in which equation F_{C1}, F_{C2} and F_{C1-2} represent the respective raw formulae of compounds (C₁), (C₂) and (C₁₋₂) and x, y and z represent rational numbers greater than or equal to 0.

As examples of material (A) there are those in which the volume proportion of compound (C₁₋₂), optionally present, tends towards 0 and/or those in which the volume proportion of optionally present compound (C₂) is greater than or equal to 0.1% and less than or equal to 10%.

Compound (C₁) is for example chosen:

either from compounds of formula (Ia):

La₁₋ₓ₋ᵤMα′ₓMα″ᵤMβ_{1-y-v}Mβ′_{y}Mβ″ᵥO_{3-w} (Ia),

corresponding to formula (I), in which Mα represents a lanthanum atom;
or from compounds of formula (Ib):

Mα₁₋ₓ₋ᵤSrₓMα″ᵤMβ_{1-y-v}Mβ′_{y}Mβ″ᵥO_{3-w} (Ib),

corresponding to formula (I), in which Mα′ represents a strontium atom;
or from compounds of formula (Ic):

Mα₁₋ₓ₋ᵤMα′ₓMα″ᵤFe_{1-y-v}Mβ′_{y}Mβ″ᵥO_{3-w} (Ic),

corresponding to formula (I), in which Mβ represents an iron atom;
or compound (C₁) is chosen:
either from compounds of formula (Id):

La₁₋ₓ₋ᵤSrₓMα′ᵤFe_{1-y-v}Mβ′_{y}Mβ″ᵥO_{3-w} (Id),

corresponding to formula (Ia) in which Mα′ represents a strontium atom and Mβ represents an iron atom;
or from compounds of formula (Ie):

La₁₋ₓ₋ᵤMα′ₓAlᵤFe_{1-y-v}Mβ′_{y}Mβ″ᵥO_{3-w} (Ie),

corresponding to formula (Ia) in which Mα″ represents an aluminium atom and Mβ represents an iron atom;
or from compounds of formula (If):

La₁₋ₓSrₓFe_{1-y}Mβ′_{y}O_{3-w} (If),

corresponding to formula (Ia) in which Mα′ represents a strontium atom, Mβ represents an iron atom and u and v are equal to 0;
or from compounds of formula (Ig):

La₁₋ᵤCaᵤFe_{1-y}Mβ′_{y}O_{3-w} (Ig),

corresponding to formula (Ia) in which Mα′represents a calcium atom, Mβ represents an iron atom and x and v are equal to 0;
or from compounds of formula (Ih):

La₁₋ᵤBaᵤFe_{1-y}Mβ′_{y}O_{3-w} (Ih),

corresponding to formula (Ia) in which Mα′ represents a barium atom, Mβ represents an iron atom and x and v are equal to 0;
or from compounds of formula (Ii):

La₁₋ₓ₋ᵤSrₓCaᵤFe_{1-y-v}Mβ′_{y}Mβ″ᵥO_{3-w} (Ii),

corresponding to formula (Id) in which Mα″ represents a calcium atom;
or from compounds of formula (Ij):

La₁₋ₓ₋ᵤSrₓBaᵤFe_{1-y-v}Mβ′_{y}Mβ″ᵥO_{3-w} (Ij),

corresponding to formula (Id) in which Mα″ represents a barium atom.

As examples of compounds according to the above formulae, there are for example compounds (C₁) chosen from compounds of formulae: La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w}, La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w}, La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, La₁₋ₓ₋ᵤSrₓBaᵤFe_{1-y}GaᵥO_{3-w}, La₁₋ₓSrₓFe_{1-y}Ti_{y}O_{3-w}, La₁₋ᵤCaᵤFe_{1-y}Ti_{y}O_{3-w}, La₁₋ᵤBaᵤFe_{1-y}Ti_{y}O_{3-w}, La₁₋ₓSrₓFe_{1-y}GaᵥO_{3-w}, La₁₋ᵤCaᵤFe_{1-y}GaᵥO_{3-w}, La₁₋ᵤBaᵤFe_{1-y}GaᵥO_{3-w}, La₁₋ᵤBaᵤFeO_{3-w}, La₁₋ᵤCaᵤFeO_{3-w} or La₁₋ₓSrₓFeO_{3-w}, and more particularly from those of formulae: La_{0.6}Sr_{0.4}Fe_{0.9}Ga_{0.1}O_{3-w}, La_{0.5}Sr_{0.1}Fe_{0.9}Ga_{0.1}O_{3-w}, La_{0.5}Sr_{0.5}Fe_{0.9}Ti_{0.1}O_{3-w}, La_{0.9}Sr_{0.1}Fe_{0.9}Ti_{0.1}O_{3-w}, La_{0.6}Sr_{0.4}Fe_{0.2}Co_{0.8}O_{3-w} or La_{0.9}Sr_{0.1}Fe_{0.2}Co_{0.8}O_{3-w}.

In material (A) as defined above, compound (C₂) is chosen from magnesium oxide (MgO), calcium oxide (CaO), aluminium oxide (Al₂O₃), zirconium oxide (ZrO₂), titanium oxide (TiO₂), mixed strontium aluminium oxides SrAl₂O₄ or Sr₃Al₂O₆, mixed barium titanium oxide (BaTiO₃), mixed calcium titanium oxide (CaTiO₃), La_{0.5}Sr_{0.5}Fe_{0.9}Ti_{0.1}O_{3-δ} or La_{0.6}Sr_{0.4}Fe_{0.9}Ga_{0.1}O_{3-δ}.

### ILLUSTRATIVE EXAMPLE

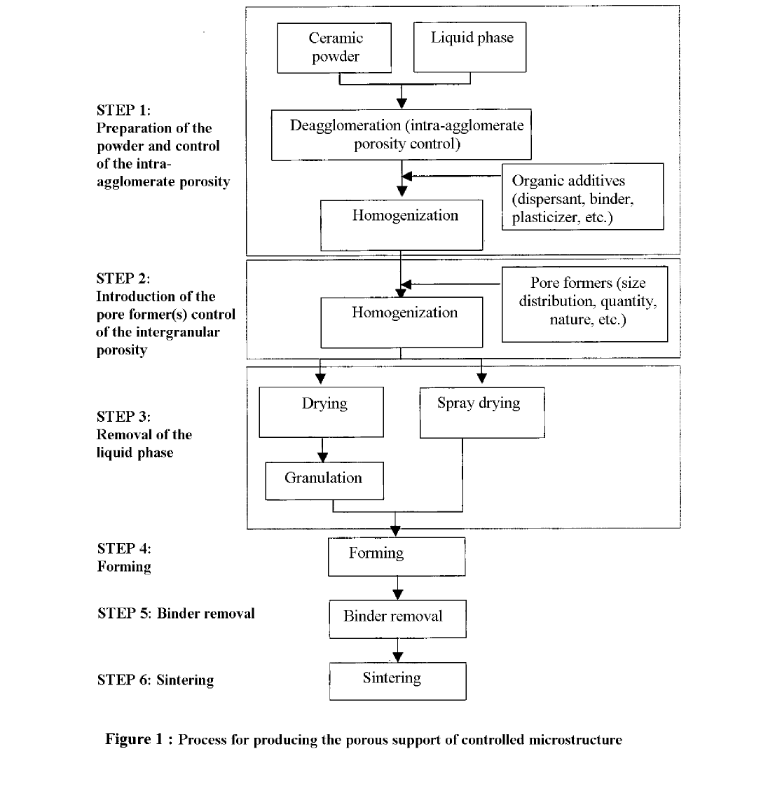

FIG. 1 illustrates a set of steps of the claimed process. A porous ceramic is prepared by carrying out this process starting from an La_{0.5}Sr_{0.5}Fe_{0.9}Ti_{0.1}O_{3-w} ceramic powder.

### Step (a): Deagglomeration

The ceramic powder is deagglomerated in ethanol with the setpoint parameters in the following table:

| The volume | | | | | Mass of |
|---|---|---|---|---|---|
| occupied by | Ball | Jar rotation | Rotation | Jar | ceramic |
| the balls | material | speed | time | volume | powder |
| 0.3 litres | ZrO₂ | 700 rpm | 12 hours | 1 litre | 1 kg |

Step (a1): Introduction of Additives

After step (a), x % by weight of phospholan (a dispersant) is introduced and the deagglomeration is continued for a further 5 hours.

### Step (b): Incorporation of Pore Formers

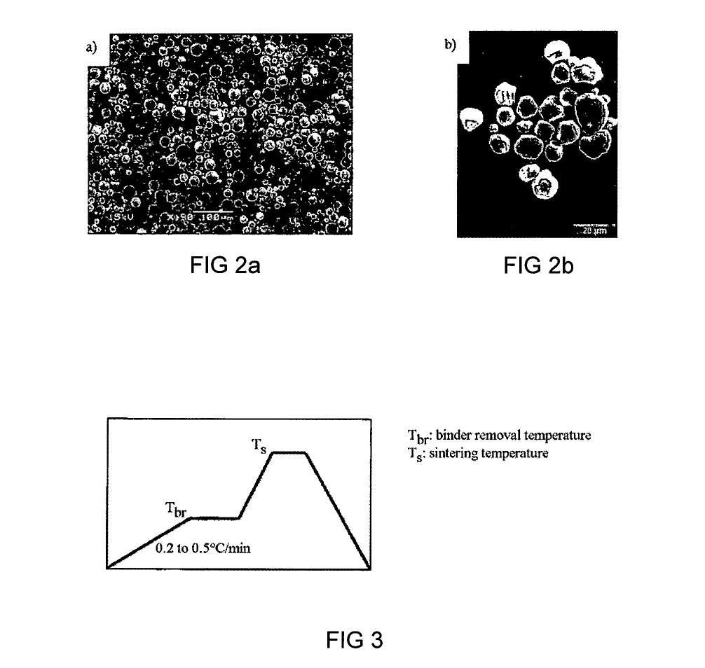

FIG. 2a is a SEM (scanning electron microscope) photograph of the PMMA (polymethyl methacrylate) used as pore former in the present example. Its particle size distribution is between 5 μm and 40 μm. The compound is added by simply mixing it in the jar. FIG. 2b is an SEM photograph of corn starch. After this step, the ceramic powder contains 30 to 40% of its mass as organic substances.

### Step (c): Removal of the Solvent

The ethanol is removed by means of a rotary evaporator.

### Step (d): Forming of the Powder Agglomerates

Powder agglomerates are prepared by the granulation technique, by spraying the suspension onto an inclined rotating plate.

Steps (e) (f): Binder Removal then Preform Sintering

The densification cycle comprises two steps: binder removal and sintering. An example of a cycle is illustrated in FIG. 3. For the present material, the binder removal temperature (T_{br}) is about 650° C. for 1 hour and the sintering temperature (Tₛ) about 1250° C. for 30 minutes.

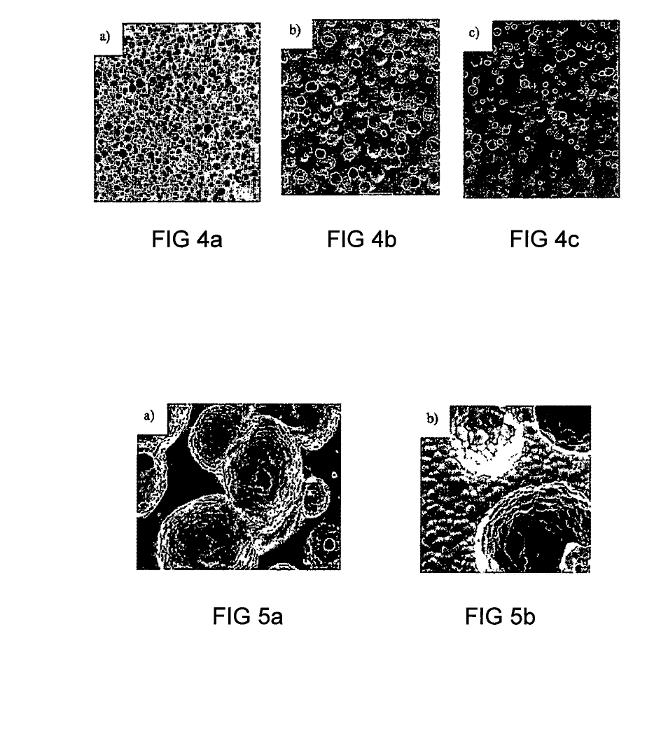

FIG. 4 illustrates examples of microstructures obtained with the claimed process. Photograph 4a) shows a microstructure obtained with a high pore former content (55 vol %). The pores are interconnected and represents about 40% of the volume of material. The pore size distribution is similar to the particle size distribution of the pore former. In this case, the porosity due to the pore former is predominant and will be greater the larger the quantity of pore former. For a threshold level of pore former corresponding to percolation, the porosity may be open and interconnected. However, thorough sintering of the part may result, depending on the case, in closed porosity.

Photograph 4b) (40 vol % pore former) and photograph 4c) (35 vol % pore former) show that it is possible to obtain closed porosity, the total volume of which is controlled by the content of pore former introduced into the starting powder.

FIG. 5a) demonstrates the interconnections between the pores and the compactness of the ceramic between the pores (particle size, intra-strand porosity). In the ceramics, the mechanical strength is dependent on the particle size and in a porous material on the shape and size of the pores. A spherical particle shape and small pores result in optimum mechanical properties. This control of the pore distribution, of the shape and size of the pores and also of the particle size is the direct consequence of the process implemented as described in FIG. 1.

FIG. 5b) illustrates the possibility of controlling the shape of the pores and the distribution of the porosity. In this case, the pore former is localized between the ceramic particle agglomerates. When ceramic agglomerates are used, the sintering may be adjusted in order to retain a residual porosity of different size from that provided by the pore former. Under these conditions, the porosity is obtained by two methods: particle stacking and introduction of a pore former. By reducing the amount of pore former, the structure tends towards a predominantly stacking porosity. The deagglomeration step makes it possible to modify the size distribution of the agglomerates and therefore to vary the intra-agglomerate porosity.

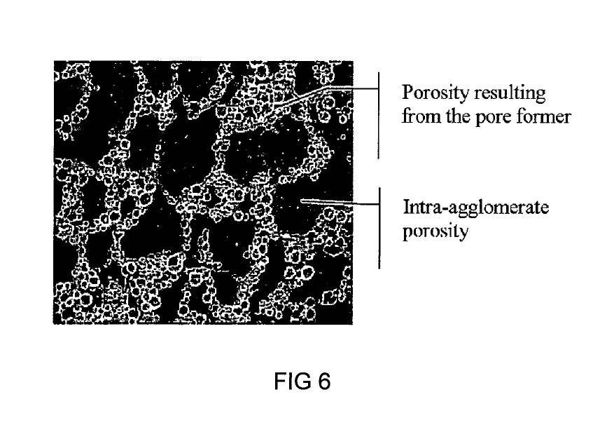

FIG. 6 demonstrates the residual intra-agglomerate porosity. This is fine porosity, which may be open depending on the heat treatment applied to the material.

1-11. (canceled)

12. A process for producing a ceramic part from a ceramic powder, comprising the following successive steps:
(a) deagglomerating a ceramic powder in a liquid to provide a powder dispersion;
(b) introducing into the powder dispersion produced in step (a) one or more additives selected from the group consisting of dispersants, binders, plasticizers, and combinations thereof;
(c) incorporating pore formers into the powder dispersion produced in step (b);
(d) removing the liquid medium from the powder dispersion produced in step (c);
(e) forming agglomerates from the powder produced in step (d) to form an agglomerated powder;
(f) removing the binder from the agglomerated powder produced in step (e); and
(g) sintering the agglomerated powder dispersion produced in step (f).

13. The process as defined in claim 12, in which said step (d) of removing the liquid medium is carried out by evaporation or by spray-drying the powder dispersion produced in step (c).

14. The process as defined in claim 12, in which step (e) is carried out by isostatic pressing, uniaxial pressing, injection moulding, extrusion or tape casting of the powder prepared in step (d).

15. The process as defined in claim 12, in which the ceramic power employed is of material (A) comprising:
(i)—at least 75% by volume and at most 100% by volume of a compound (C₁) chosen from doped ceramic oxides which, at a use temperature, have a form of a crystal lattice with oxide ion vacancies of perovskite phase, of formula (I):
Mα₁₋ₓ₋ᵤMα′ₓMα″ᵤMβ_{1-y-v}Mβ′_{y}Mβ″ᵥO_{3-w} (I)
in which:
Mα represents an atom chosen from scandium, yttrium or from the families of lanthanides, actinides or alkaline-earth metals;
Mα′, which differs from Mα, represents an atom chosen from scandium, yttrium or from the families of lanthanides, actinides or alkaline-earth metals;
Mα″, which differs from Mα and Mα′, represents an atom chosen from aluminium (Al), gallium (Ga), indium (In), thallium (Tl) or from the family of alkaline-earth metals;
Mβ represents an atom chosen from transition metals;
Mβ′, which is different from Mβ, represents an atom chosen from transition metals, aluminium (Al), indium (In), gallium (Ga), germanium (Ge), antimony (Sb), bismuth (Bi), tin (Sn), lead (Pb) or titanium (Ti);
Mβ″, which differs from Mβ and Mβ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9
and w is such that the structure in question is electrically neutral;
(ii)—optionally up to 25% by volume of a compound (C₂), which differs from compound (C₁), chosen from oxide-type materials, non-oxide-type materials, or a metal Q, wherein,
said oxide-type materials are selected from the group consisting of boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂), ceria (CeO₂), strontium-aluminium mixed oxide SrAl₂O₄, strontium-aluminium mixed oxide Sr₃Al₂O₆, barium-titanium mixed oxide (BaTiO₃), calcium-titanium mixed oxide (CaTiO₃), aluminium and/or magnesium silicates, calcium phosphates and calcium phosphate derivatives, and materials of the perovskite type,
said materials of the non-oxide type are selected from the group consisting of carbides, nitrides, nickel (Ni), platinum (Pt), palladium (Pd), rhodium (Rh), and combinations thereof; and
(iii)—optionally up to 2.5% by volume of a compound (C₁₋₂) produced from at least one chemical reaction represented by the equation:
xF_{C1}+yF_{C2}------>zF_{C1-2},
in which equation F_{C1}, F_{C2} and F_{C1-2} represent the respective raw formulae of compounds (C₁), (C₂) and (C₁₋₂) and x, y and z represent rational numbers greater than or equal to 0.

16. The process as defined in claim 15, wherein said aluminium and/or magnesium silicates are selected from the group consisting of mullite (2SiO₂.3Al₂O₃), cordierite (Mg₂Al₄Si₅O₁₈), and spinel phase MgAl₂O₄.

17. The process as defined in claim 15, wherein said calcium phosphates and their derivatives are selected from the group consisting of hydroxyapatite Ca₁₀(PO₄)₆(OH)₂ and tricalcium phosphate Ca₃(PO₄)₂.

18. The process as defined in claim 15, wherein said materials of the perovskite type are selected from the group consisting of La_{0.5}Sr_{0.5}Fe_{0.9}Ti_{0.1}O_{3-δ}, La_{0.6}Sr_{0.4}Fe_{0.9}Ga_{0.1}O_{3-δ}, La_{0.5}Sr_{0.5}Fe_{0.9}Ga_{0.1}O_{3-δ}, and La_{0.6}Sr_{0.4}Fe_{0.9}Ti_{0.1}O_{3-δ},

19. The process as defined in claim 15, wherein said carbide is silicon carbide (SiC).

20. The process as defined in claim 15, wherein said nitrides are selected from the group consisting of boron nitride (BN), aluminium nitride (AlN) or silicon nitride (Si₃N₄), and sialons (SiAlON).

21. The process as defined in claim 15, wherein the volume proportion of compound (C₁₋₂) tends towards 0.

22. The process as defined in claim 15, wherein the volume proportion of compound (C₂) is in a range of greater than or equal to 0.1% to less than or equal to 10%.

23. The process as defined in claim 15, wherein compound (C₁) is selected from the group consisting of compounds of the formula La₁₋ₓ₋ᵤMα′ₓMα″ᵤMβ_{1-y-v}Mβ′_{y}Mβ″ᵥO_{3-w} where Mα represents a lanthanum atom, compounds of the formula Mα₁₋ₓ₋ᵤSrₓMα″ᵤMβ_{1-y-v}Mβ′_{y}Mβ″ᵥO_{3-w} where Mα′ represents a strontium atom, and compounds of the formula Mα₁₋ₓ₋ᵤMα′ₓMα″ᵤFe_{1-y-v}Mβ′_{y}Mβ″ᵥO_{3-w} where Mβ represents an iron atom.

24. The process as defined in claim 23, wherein compound (C₁) is selected from the group consisting of: compounds of the formula La₁₋ₓ₋ᵤSrₓMα″ᵤFe_{1-y-v}Mβ′_{y}Mβ″ᵥO_{3-w} where Mα′ represents a strontium atom and Mβ represents an iron atom; compounds of the formula La₁₋ₓ₋ᵤMα′ₓAlᵤFe_{1-y-v}Mβ′_{y}Mβ″ᵥO_{3-w} where Mα″ represents an aluminium atom and Mβ represents an iron atom; compounds of the formula La₁₋ₓSrₓFe_{1-y}Mβ′_{y}O_{3-w} where Mα′ represents a strontium atom, Mβ represents an iron atom and u and v are equal to 0; compounds of the formula La₁₋ᵤCaᵤFe_{1-y}Mβ′_{y}O_{3-w} where Mα′ represents a calcium atom, Mβ represents an iron atom and x and v are equal to 0; compounds of the formula La₁₋ᵤBaᵤFe_{1-y}Mβ′_{y}O_{3-w} where Mα′ represents a barium atom, Mβ represents an iron atom and x and v are equal to 0; compounds of the formula La₁₋ₓ₋ᵤSrₓCaᵤFe_{1-y-v}Mβ′_{y}Mβ″ᵥO_{3-w} where Mα″ represents a calcium atom; and compounds of the formula La₁₋ₓ₋ᵤSrₓBaᵤFe_{1-y-v}Mβ′_{y}Mβ″ᵥO_{3-w} where Mα″ represents a barium atom.

25. The process as defined in claim 24, wherein compound (C₁) is a compound selected from the group consisting of:
La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w}, La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w}, La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, La₁₋ₓ₋ᵤSrₓBaᵤFe_{1-y}GaᵥO_{3-w}, La₁₋ₓSrₓFe_{1-y}Ti_{y}O_{3-w}, La₁₋ᵤCaᵤFe_{1-y}Ti_{y}O_{3-w}, La₁₋ᵤBaᵤFe_{1-y}Ti_{y}O_{3-w}, La₁₋ₓSrₓFe_{1-y}GaᵥO_{3-w}, La₁₋ᵤCaᵤFe_{1-y}GaᵥO_{3-w}, La₁₋ᵤBaᵤFe_{1-y}GaᵥO_{3-w}, La₁₋ᵤBaᵤFeO_{3-w}, La₁₋ᵤCaᵤFeO_{3-w}, and La₁₋ₓSrₓFeO_{3-w},

26. The process as defined in claim 25, wherein compound (C₁) is a compound selected from the group consisting of: La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, La_{0.9}Sr_{0.1}Fe_{0.9}Ti_{0.1}O_{3-w}, La_{0.6}Sr_{0.4}Fe_{0.2}Co_{0.8}O_{3-w}, and La_{0.9}Sr_{0.1}Fe_{0.2}Co_{0.8}O_{3-w}.

27. The process as defined in claim 15, wherein compound (C₂) is selected from the group consisting of magnesium oxide (MgO), calcium oxide (CaO), aluminium oxide (Al₂O₃), zirconium oxide (ZrO₂), titanium oxide (TiO₂), mixed strontium aluminium oxide SrAl₂O₄, mixed strontium aluminium oxides Sr₃Al₂O₆, mixed barium titanium oxide (BaTiO₃), mixed calcium titanium oxide (CaTiO₃), and La_{0.5}Sr_{0.5}Fe_{0.9}Ti_{0.1}O_{3-δ} or La_{0.6}Sr_{0.4}Fe_{0.9}Ga_{0.1}O_{3-δ}.
